(19) United States
(12) Patent Application Publication
(10) Pub. No.: US 2018/0084826 A1
(43) Pub. Date: Mar. 29, 2018

(54) PORTABLE CIGAR ASHTRAY

(71) Applicant: Basil Walkes, Wilson, NC (US)

(72) Inventor: Basil Walkes, Wilson, NC (US)

(21) Appl. No.: 15/276,959

(22) Filed: Sep. 27, 2016

(51) Int. Cl. A24F 19/10; A24F 19/00; A24F 13/24; B60N 3/08

(52) U.S. Cl. CPC A24F 19/10; A24F 19/0035; B60N 3/083; A24F 13/24; A24F 19/0092

(57) ABSTRACT

A portable cigar ashtray for use in a cup holder of a vehicle includes a shell that has a bottom. A wall is coupled to and extends upwardly from the bottom. The wall has an upper perimeter defining a top of the shell, which is open. A rim that is complementary to the upper perimeter is coupled to the upper perimeter. A plurality of retainers is coupled to the rim. A blade is coupled to the rim. The shell is configured to insert into a cup holder. The retainers are positioned on the rim and are configured to maintain a lit end of a cigar in position over the top of the shell. The blade is positioned on the rim and is configured to cut off a head end of the cigar.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to ashtrays and more particularly pertains to a new ashtray for use in a cup holder of a vehicle.

### BRIEF SUMMARY OF THE INVENTION

An embodiment of the disclosure meets the needs presented above by generally comprising a shell that has a bottom. A wall is coupled to and extends upwardly from the bottom. The wall has an upper perimeter defining a top of the shell, which is open. A rim that is complementary to the upper perimeter is coupled to the upper perimeter. A plurality of retainers is coupled to the rim. A blade is coupled to the rim. The shell is configured to insert into a cup holder. The retainers are positioned on the rim and are configured to maintain a lit end of a cigar in position over the top of the shell. The blade is positioned on the rim and is configured to cut off a head end of the cigar.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a portable cigar ashtray according to an embodiment of the disclosure.

FIG. 2 is a top view of an embodiment of the disclosure.

FIG. 3 is a cross-sectional view of an embodiment of the disclosure.

### DETAILED DESCRIPTION OF THE INVENTION

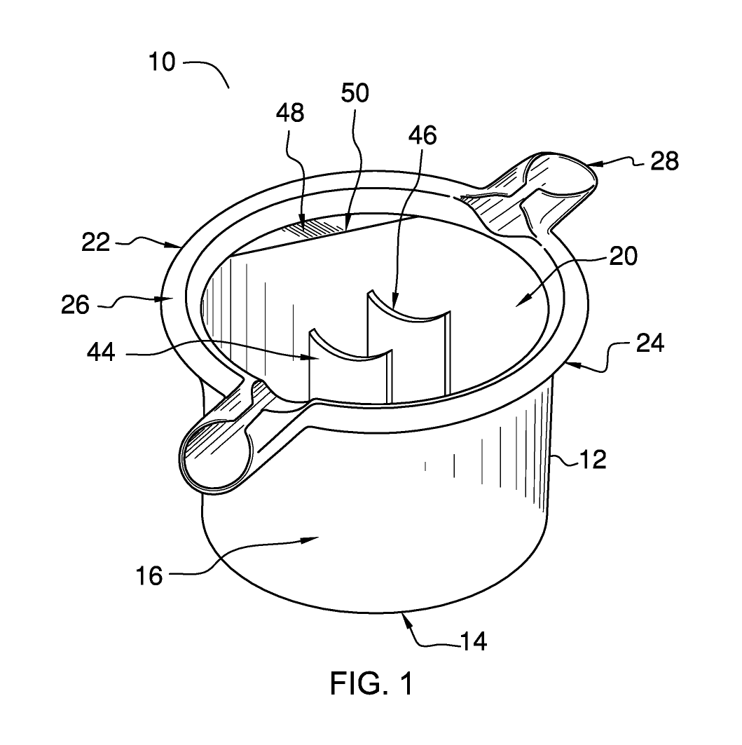

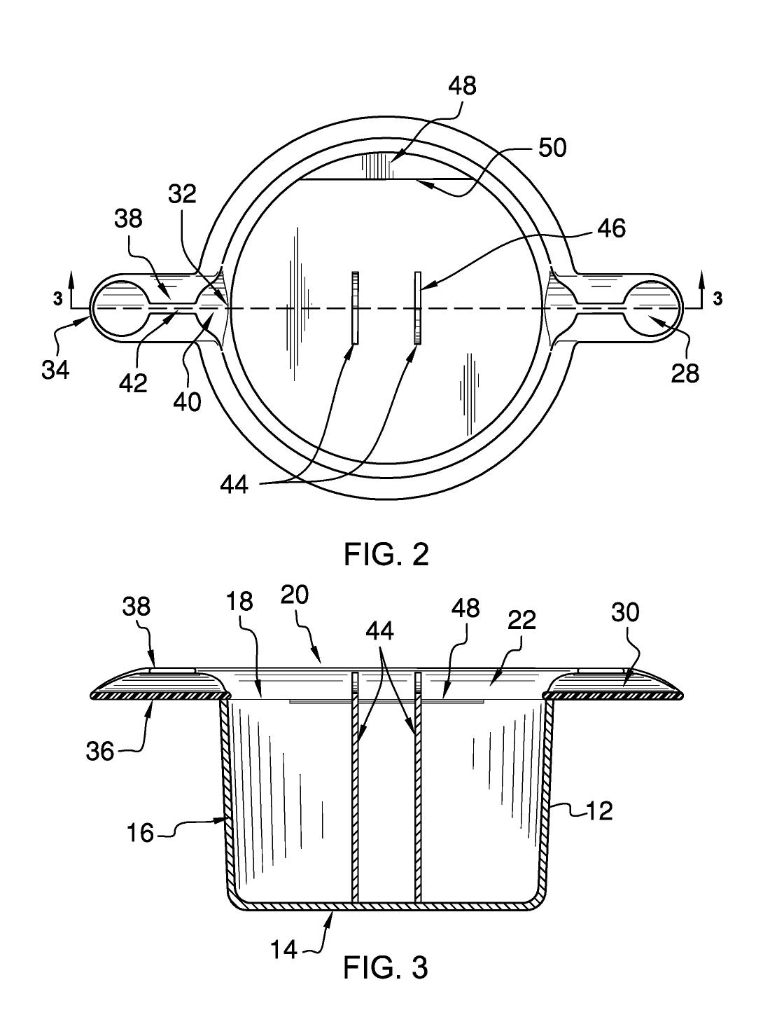

With reference now to the drawings, and in particular to FIGS. 1 through 3 thereof, a new ashtray embodying the principles and concepts of an embodiment of the disclosure and generally designated by the reference numeral 10 will be described.

As best illustrated in FIGS. 1 through 3, the portable cigar ashtray 10 generally comprises a shell 12 that has a bottom 14. A wall 16 is coupled to and extends upwardly from the bottom 14. The wall 16 has an upper perimeter 18 that defines a top 20 of the shell 12. The top 20 is open. The bottom 14 is circularly shaped. The wall 16 extends perpendicularly from the bottom 14, such that the shell 12 is cylindrical and configured to insert into a cup holder. The shell 12 comprises metal. The shell 12 comprises stainless steel.

In one embodiment, the top 20 and the bottom 14 are separated by from four to twelve centimeters. The upper perimeter 18 measures from sixteen to thirty two centimeters. In another embodiment, the top 20 and the bottom 14 are separated by from six to nine centimeters. The upper perimeter 18 measures from twenty to twenty eight centimeters. In yet another embodiment, the top 20 and the bottom 14 are separated by seven and six tenths centimeters. The upper perimeter 18 measures twenty four centimeters.

The ashtray 10 comprises a rim 22 that is complementary to and coupled to the upper perimeter 18. The rim 22 extends outwardly from the upper perimeter 18, defining a lip 24. The rim 22 has upper surface 26. The upper surface 26 is rounded. The rim 22 comprises plastic.

A plurality of retainers 28 is coupled to the rim. The retainers 28 are positioned on the rim 22 and are configured to maintain a lit end of a cigar in position over the top 20 of the shell 12. The plurality of retainers 28 comprises two retainers 28. The retainers 28 are opposingly positioned on the rim.

In one embodiment, each retainer 28 comprises a tube 30 that is coupled to the rim 22 and extends transversely from the wall 16. The tube 30 is open-ended. The tube 30 is configured to insert the cigar through the tube 30 such that the lit end of the cigar is maintained in position over the top 20 of the shell 12. The tube 30 comprises a first end 32 that is coupled to the rim 22 and a second end 34, which extends away from the rim 22. The second end 34 is tapered, such that a lower face 36 of the tube 30 is dimensionally longer than an upper face 38 of the tube 30.

The tube 30 comprises a cutout 40. The cutout 40 is positioned in the upper face 38 and extends from the first end 32 toward the second end 34. The cutout 40 is arcuate. The tube 30 also comprises a slot 42 that is positioned in the upper face 38. The slot 42 extends from the cutout 40 to the second end 34 of the tube 30.

A plurality of slats 44 is coupled to and extends perpendicularly from the bottom 14 toward the top 20. Each slat 44 has an upper edge 46. The slats 44 are positioned in the shell 12 such that the upper edges 46 are configured to remove ashes from the lit end of the cigar. The upper edges 46 are concavely curved. The plurality of slats 44 comprises two slats 44. The slats 44 are positioned in parallel. The slats 44 are substantially centrally positioned on the bottom 14. The upper edges 46 of the slats 44 are in substantial horizontal alignment with the lower faces 36 of the tubes 30. The slats 44 comprise metal. The slats 44 comprise stainless steel.

A blade 48 is coupled to the rim 22. The blade 48 is positioned on the rim 22 such that the blade 48 is configured to cut off a head end of the cigar. In one embodiment, the blade 48 is positioned on the rim 22 such that said blade is substantially parallel to the bottom 14 of the shell 12. A cutting edge 50 of the blade 48 faces the slats 44.

The present invention also anticipates a lid that is complementary to and reversibly couplable to the rim. The lid retains ashes from the cigar within the shell 12.

In use, the shell 12 is configured to insert into the cup holder. The tube 30 is configured to insert the cigar through the tube 30 such that the lit end of the cigar is maintained in position over the top 20 of the shell 12. The slats 44 are positioned in the shell 12 such that the upper edges 46 are configured to remove ashes from the lit end of the cigar. The blade 48 is positioned on the rim 22 such that the blade 48 is configured to cut off the head end of the cigar.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable cigar ashtray comprising:
a shell comprising a bottom and a wall coupled to and extending upwardly from said bottom, said wall having an upper perimeter defining a top of said shell, said top being open;
a rim complementary to and coupled to said upper perimeter;
a plurality of retainers coupled to said rim;
a blade coupled to said rim; and
wherein said shell is configured for insertion into a cup holder, wherein said retainers are positioned on said rim such that said retainers are configured to maintain a lit end of a cigar in position over said top of said shell, wherein said blade is positioned on said rim such that said blade is configured to cut off a head end of the cigar.

2. The ashtray of claim 1, further including said bottom being circularly shaped, said wall extending perpendicularly from said bottom, such that said shell is cylindrical and configured for insertion into a cup holder.

3. The ashtray of claim 2, further comprising:
said top and said bottom being separated by from four to twelve centimeters; and
said upper perimeter measuring from sixteen to thirty two centimeters.

4. The ashtray of claim 3, further comprising:
said top and said bottom being separated by from six to nine centimeters; and
said upper perimeter measuring from twenty to twenty eight centimeters.

5. The ashtray of claim 4, further comprising:
said top and said bottom being separated by seven and six tenths centimeters; and
said upper perimeter measuring twenty four centimeters.

6. The ashtray of claim 2, further including said rim extending outwardly from said upper perimeter defining a lip, said rim having an upper surface, said upper surface being rounded.

7. The ashtray of claim 6, further including said rim comprising plastic.

8. The ashtray of claim 1, further including said plurality of retainers comprising two said retainers.

9. The ashtray of claim 8, further including said retainers being opposingly positioned on said rim.

10. The ashtray of claim 9, further including each said retainer comprising a tube coupled to said rim and extending transversely from said wall, said tube being open-ended, such that said tube is configured for insertion of the cigar through said tube such that the lit end of the cigar is maintained in position over said top of said shell.

11. The ashtray of claim 10, further including said tube comprising
a first end coupled to said rim;
a second end extending away from said rim, said second end being tapered, such that a lower face of said tube is dimensionally longer than an upper face of said tube; and
a cutout positioned in said upper face and extending from said first end toward said second end, said cutout being arcuate.

12. The ashtray of claim 11, further including a slot positioned in said upper face, said slot extending from said cutout to said second end of said tube.

13. The ashtray of claim 12, further including a plurality of slats coupled to and extending perpendicularly from said bottom toward said top, each said slat having an upper edge, wherein said slats are positioned in said shell such that said upper edges are configured for removing ashes from the lit end of the cigar.

14. The ashtray of claim 13, further including said upper edges being concavely curved.

15. The ashtray of claim 14, further including said plurality of slats comprising two said slats, said slats being positioned in parallel, said slats being substantially centrally positioned on said bottom, said upper edges of said slats being in substantial horizontal alignment with said lower faces of said tubes.

16. The ashtray of claim 13, further including said shell and said slats comprising metal.

17. The ashtray of claim 16, further including said shell and said slats comprising stainless steel.

18. The ashtray of claim 15, further including said blade being positioned on said rim such that said blade is substantially parallel to said bottom, wherein a cutting edge of said blade faces said slats.

19. A portable cigar ashtray comprising:
a shell comprising a bottom and a wall coupled to and extending upwardly from said bottom, said wall having an upper perimeter defining a top of said shell, said top being open, said bottom being circularly shaped, said wall extending perpendicularly from said bottom, such that said shell is cylindrical and configured for insertion into a cup holder, said shell comprising metal, said shell comprising stainless steel, said top and said bottom being separated by from four to twelve centimeters, said upper perimeter measuring from sixteen to thirty two centimeters, said top and said bottom being separated by from six to nine centimeters, said upper perimeter measuring from twenty to twenty eight centimeters, said top and said bottom being separated by seven and six tenths centimeters, said upper perimeter measuring twenty four centimeters;
a rim complementary to and coupled to said upper perimeter, said rim extending outwardly from said upper perimeter defining a lip, said rim having an upper surface, said upper surface being rounded, said rim comprising plastic;
a plurality of retainers coupled to said rim, wherein said retainers are positioned on said rim such that said retainers are configured to maintain a lit end of a cigar in position over said top of said shell, said plurality of retainers comprising two said retainers, said retainers being opposingly positioned on said rim, each said retainer comprising a tube coupled to said rim and extending transversely from said wall, said tube being open-ended, such that said tube is configured for insertion of the cigar through said tube such that the lit end of the cigar is maintained in position over said top of said shell, said tube comprising a first end coupled to said rim and a second end, said second end extending away from said rim, said second end being tapered, such that a lower face is dimensionally longer than an upper face of said tube, said tube comprising a cutout, said cutout being positioned in said upper face and extending from said first end toward said second end, said cutout being arcuate, said tube comprising a slot positioned in said upper face, said slot extending from said cutout to said second end of said tube;
a plurality of slats coupled to and extending perpendicularly from said bottom toward said top, each said slat having an upper edge, wherein said slats are positioned in said shell such that said upper edges are configured for removing ashes from the lit end of the cigar, said upper edges being concavely curved, said plurality of slats comprising two said slats, said slats being positioned in parallel, said slats being substantially centrally positioned on said bottom, said upper edges of said slats being in substantial horizontal alignment with said lower faces of said tubes, said slats comprising metal, said slats comprising stainless steel;
a blade coupled to said rim, wherein said blade is positioned on said rim such that said blade is configured to cut off a head end of the cigar, said blade being positioned on said rim such that said blade is substantially parallel to said bottom, wherein a cutting edge of said blade faces said slats; and
wherein said shell is configured for insertion into a cup holder, wherein said tube is configured for insertion of the cigar through said tube such that the lit end of the cigar is maintained in position over said top of said shell, wherein said slats are positioned in said shell such that said upper edges are configured for removing ashes from the lit end of the cigar, wherein said blade is positioned on said rim such that said blade is configured to cut off a head end of the cigar.
